(19) United States
(12) Patent Application Publication
(10) Pub. No.: US 2009/0303277 A1
(43) Pub. Date: Dec. 10, 2009

(54) Image detection device of inkjet printing machine

(76) Inventor: Jia-Hong Cheng, Nanhua Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/320,148

(22) Filed: Jan. 21, 2009

(30) Foreign Application Priority Data
Jun. 9, 2008 (TW) 097210179

(51) Int. Cl. B41J 29/393

(52) U.S. Cl. 347/19

(57) ABSTRACT

An image detection device of inkjet printing machines is revealed. The image detection device of inkjet printing machines mainly includes an image detector connected with a print head of the inkjet printing machine. The image detector moves along with the print head so that the image detector detects figures and words printed by the print head in real time for learning whether the print head printed the printed figures and words correctly. If there are some printing defects, this means that the print head is obstructed. Through the image detection device, the inkjet printing machine runs a cleaning process and prints figures as well as words after complete cleaning of the print head. Thereby, figures and words are printed continually and precisely, without printing defects caused by obstruction of the print head. Therefore, not only the operation is simplified and convenient, but the labor cost is reduced and the working efficiency is improved. The practical value of the device is increased.

### BACKGROUND OF THE INVENTION

1. Field of Invention

The present invention relates to an image detection device of inkjet printing machines is revealed, especially to an image detection device that knows whether a print head is obstructed during printing processes of figures as well as words and makes the print head run a cleaning process for printing of figures and words continually and precisely. Thus printing defects caused by obstruction of the print head can be avoided. The practical value of inkjet printing machines is increased.

2. Brief Description of the Prior Art

With the rapid development of computer technology, various automatic machines and equipment that are controlled by computer commands are used broadly in our daily lives. One of them is a large inkjet printing machine. In the everyday lives, there are a plurality of advertisings, signs, and billboards in our surroundings. The figures or characters on these advertisements, signs, or billboards are painted manually in earlier days. Considering cost of labors, operation speed, and working quality, manual printing is gradually replaced by inkjet printing of machines.

The large inkjet printing machine includes a plurality of ink cartridges with various colors of pigment ink disposed thereon and each of the ink cartridges is connected with a print head on the machine. Under the control of computer command, the print heads on the machine move along with print lines of desired figures and characters and eject ink with required colors at certain positions. Thus printing of large-scale images is done with reduced cost, less time, higher operation efficiency and better working quality.

During printing processes of the large inject printing machine, the required figures and words are unable to be printed exactly as they were designed, or are to be printed intermittently due to obstruction of the print head. Thus a person is required to monitor the printed figures and words for checking defects. Once the person finds that the print head is obstructed and the figures and words are unable to be printed correctly, he needs to operate the inkjet printing machine for running a cleaning of the print head. After completing the cleaning process, the inkjet printing machine starts printing processes continually.

However, although the problem of defects on figures and words during the printing processes caused by obstruction of the print head can be solved by the staff that monitors printing of the inkjet printing machine, such operation way of the inkjet printing machine is quite inconvenient in practice and the labor cost keeps rising. The cleaning of the print head is run after the staff found the obstruction of the print head. Thus there is a time delay and this way takes quite a lot of working time. There is a need to provide a new type inkjet printing machine that overcomes these shortcomings of conventional devices.

### SUMMARY OF THE INVENTION

Therefore it is a primary object of the present invention to provide an image detection device of inkjet printing machines. The inkjet printing machine is disposed with the image detection device that includes an image detector connected with a print head and moving along with the print head. Thus during printing processes of figures and words, the image detector checks the printed figures and words immediately so as to know whether the print head printed the figures as well as words correctly. If not, this represents the print head is obstructed. Through the image detection device, a cleaning of the print head is run in time. After finishing the cleaning, the inkjet printing machine continues printing figures and words. Thereby, the figures and words are printed continually and precisely, without defects caused by obstruction of the print head. Therefore, not only the operation of the machine becomes more simplified and convenient, the labor cost is also reduced and the working efficiency is improved. The practical value of the device is enhanced.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a schematic drawing showing structure of an embodiment according to the present invention;

FIG. 2 is a partial enlarged view of the embodiment according to the present invention.

### DETAILED DESCRIPTION OF THE PREFERRED EMBODIMENT

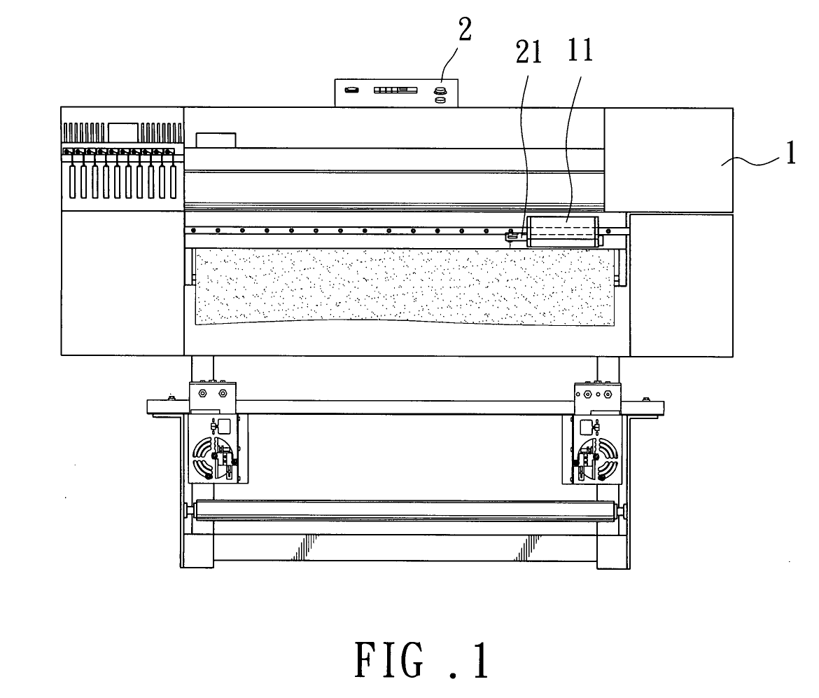

Referring to FIG. 1, a schematic drawing of whole structure of an embodiment according to the present invention is disclosed. An inkjet printing machine (1) of the present invention is disposed with a print head (11) for ejecting required colors of pigment ink that form figures and words. The inkjet printing machine (1) is further arranged with an image detection device (2) that includes an image detector (21) arranged beside the print head (11) and moving along with the movement of the printhead (11).

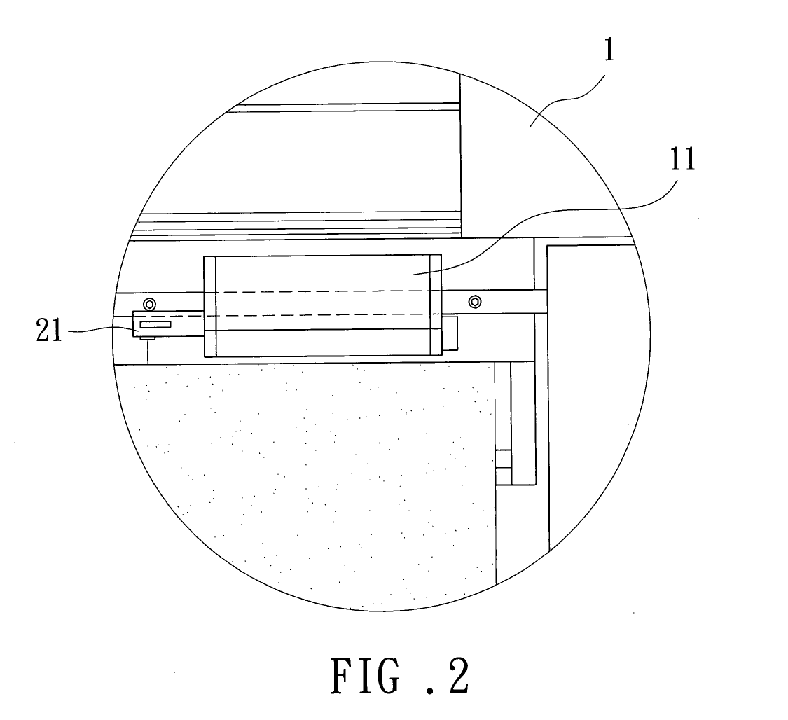

Also referring to FIG. 2, a partial enlarged view of the embodiment is revealed. While the print head (11) of the inkjet printing machine (1) printing figures and words, the image detector (21) of the image detection device (2) moves along with the movement of the print head (11). Thus the image detector (21) detects the figures as well as words printed by the print head (11) immediately so as to learn whether the print head (11) printed the figures as well as words correctly. Once there are some defects in the printed figures and words, this means that the print head (11) is obstructed. Then through the information from the image detection device (2), the inkjet printing machine (1) makes the print head (11) run a cleaning process. After complete cleaning of the print head (11), the inkjet printing machines (1) continues printing the required figures and words.

In summary, compared with structure of the devices available now, the embodiment of the present invention mainly includes the image detector of the image detection device connected with the print head of the inkjet printing machine. The image detector moves along with the movement of the print head of the inkjet printing machine so that the image detector detects the printed figures and words in real time during printing processes and makes the print head run the cleaning process while finding incorrect printing. Thus the figures and words are printed continually and precisely, without printing defects caused by obstruction of the print head. Therefore, not only the operation processes of the device are getting more simplified and convenient, but the labor cost is reduced and the working efficiency is improved. The practical value of the device is increased.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. An image detection device of an inkjet printing machine that is disposed with a print head for ejecting required colors of pigment ink to print figures and words comprising:
an image detection device disposed on the inkjet printing machine and the image detection device having an image detector connected with the print head and moving along with the print head.
